(19) United States
(12) Patent Application Publication
(10) Pub. No.: US 2018/0130090 A1
(43) Pub. Date: May 10, 2018

(54) OPTIMAL DETECTION OF THE BEST OFFER IN A CAMPAIGN

(71) Applicant: ADOBE SYSTEMS INCORPORATED, SAN JOSE, CA (US)

(72) Inventors: Kourosh MODARRESI, Los Altos, CA (US); Khashayar KHOSRAVI, Stanford, CA (US)

(21) Appl. No.: 15/348,865

(22) Filed: Nov. 10, 2016

(51) Int. Cl. G06Q 30/02

(52) U.S. Cl. CPC G06Q 30/0244; G06Q 30/0243

(57) ABSTRACT

Techniques for allocating test offers to determine a best offer in a set of offers with a desired confidence level. An allocatiton of additional test offers is determined by allocating the additional test offers unevenly, e.g., allocating more additional test offers to offer A than to offer B, etc. The test offers are allocated to test the offers in the set of offers to attain the desired confidence level that one of the offers is the best offer for the campaign. For example, this can involve allocating test offers in a way that is expected to minimize the number of additional test offers needed to attain the desired confidence level in the best offer. Additional test offers are made until a best offer is identified with the desired confidence level based on the outcome information.

### TECHNICAL FIELD

This disclosure relates generally to computer-implemented methods and systems and more particularly relates to improving the efficiency and effectiveness of computing systems used to evaluate offers and other options.

### BACKGROUND

Offers are presented to customers in various ways. For example, offers are often presented to customers when the customers use web browsers, search engines, social media applications, and other computer devices to access electronic content. Customers, as the term is used herein, are people who use computing devices to execute a web browser, use a search engine, use a social media application, or otherwise access electronic content via an electronic network. In one example, a customer is presented with an advertisement (“ad”) or promotion for a retail item when the customer accesses a particular webpage or initiates a search engine search using a particular keyword.

Marketers often have many choices of offers to provide to customers. For example, a marketer may have three offer options as illustrated in FIG. 2. In the example of FIG. 2, the offer options 201, 2020, 203 differ with respect to graphic content, text content, and text background color. However, offer options can differ from one another in other ways including, but not limited to, text font, text size, graphic size, text position, graphic position, offer format (e.g., image, text, video, and/or sound), offer distribution technique (e.g., e-mail, postal mail, keyword-based, webpage, banner, text message, social media posting, etc.), among numerous other variables.

Electronic systems used by marketers to evaluate and/or distribute offers do not provide a sufficient way for a marketer to identity which offer is the best within a set of offers. More specifically, marketers desire to know which of the offers will best achieve a desired outcome (e.g., maximum number of conversions, maximum clicks, maximum length of staying engaged, maximum website visit length, minimum response time, etc.). Marketers would like to be confident in such a determination (e.g., 95% confident that option A is the best) while also being able to make the determination with as little testing of the offers as possible. Marketers would like to detect a winning offer with some confidence and then stop testing the offers so that the winning offer can be used exclusively in the rest of the campaign. Reducing the amount of testing allows the winning offer to be used more. This improves the overall campaign performance since more of the customers will receive the best offer. For example, if the campaign will send offers to 1000 customers, it is preferable to send test offers to 100 customers and use the best offer for the remaining 900 customers than it is to send test offers to 400 customers and use the best offer for the remaining 600 customers. Marketers want to send the best offer to as many of the customers as possible and therefor to minimize the testing. Existing systems do not identify the best offer with sufficient confidence and minimal testing.

### SUMMARY

Techniques are disclosed herein for allocating test offers to determine a best offer in a set of offers with a desired confidence level. One embodiment of the invention involves receiving outcome information regarding initial test offers provided to an initial set of customers for a campaign. An allocatiton of additional test offers is determined by allocating the additional test offers unevenly, e.g., allocating more additional test offers to offer A than to offer B, etc. The additional test offers are allocated to test the offers in the set of offers to attain the desired confidence level that one of the offers is the best offer for the campaign. For example, this can involve allocating test offers in a way that is expected to minimize the number of additional test offers needed to attain the desired confidence level in the best offer. Additional outcome information for the additional test offers is received and included in the outcome information. Additional test offers are made until a best offer is identified with the desired confidence level based on the outcome information.

These illustrative features are mentioned not to limit or define the disclosure, but to provide examples to aid understanding thereof. Additional techniques are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings.

FIG. 1 illustrates an exemplary computer network environment in which techniques for comparing and distributing offers can be implemented.

FIG. 2 illustrates graphical depictions of several alternative offers to be compared with one another.

FIG. 3 is a block diagram illustrating an exemplary technique allocating test offers to determine a best offer in a set of offers with a desired confidence level.

FIG. 4 is a flow chart illustrating an exemplary technique allocating test offers to determine a best offer in a set of offers with a desired confidence level.

FIG. 5 is a flow chart illustrating an exemplary technique allocating test offers.

FIG. 6 is a flow chart illustrating an exemplary technique allocating test offers while minimizing the number of test offers used to obtain a desired level of confidence.

FIG. 7 is a flow chart illustrating an exemplary iterative technique allocating test offers.

FIG. 8 is a graphic illustrating steps of an exemplary algorithm allocating test offers to determine a best offer in a set of offers with a desired confidence level.

FIG. 9 is a block diagram depicting an example hardware implementation.

### DETAILED DESCRIPTION

As described above, existing systems used by marketers to evaluate and/or distribute offers do not identify the best offer with sufficient confidence and minimal testing. The disclosed invention addresses these and other deficiencies of existing systems by determining the best offer using techniques that optimally allocate test offers. For example, if offers A, B, and C are being compared, offer A may be sent to 150 customers, offer B may be sent to 100 customers, and offer C may be sent to 50 customers based on determining that this allocation will result in identifying the best offer using fewer total test offers than other allocations. For example, this allocation may determine the best offer using fewer total test offers compared to an allocation in which each of offers A, B, and C is sent to 150 customers. In a particular example, offer C is a very poor performing offer, offer B performs better, and offer A performs the best. Techniques of the invention identify the poor performance of C early in the offer testing process and limit the amount of customers that receive offer C in the testing process. The allocation to the various options in the testing process can be optimized to identify the best offer with a desired confidence level using a minimal number of test offers.

Techniques of the invention distribute test offers in an iterative process that, at each iteration, determines an allocation of test offers, distributes the test offers according to the allocation, and assesses the outcomes of the test offers. At each iteration, the techniques use information about the outcomes of the test offers so far to determine the allocation. Rather than simply allocating test offers equally among the offers, test offers are allocated to determine a best offer with the desired confidence using the fewest test offers. Thus, in a first iteration, since no outcomes have been received, an equal number (e.g., 1000) of each of offers A, B, and C can be sent to customers. At the next iteration, however, the allocation depends on the outcomes of those first test offers (e.g., the 3000 initial offers). For example, in the second iteration, 1000 customer may receive offer A, 1000 customers may receive offer B, and only 100 customers may receive offer C. At the next iteration, the allocation depends on the outcomes of the test offers sent so far (e.g., using all of the test offers in the first and second iterations). For example, in the third allocation, 1000 customers may receive offer A, 1000 customers may receive offer B, and 100 customers may receive offer C. At each iteration, the techniques test whether the best offer can be determined with the desired confidence level. If a best offer can be determined with the desired confidence level, the iterating and testing stops and the best offer is identified for use. For example, a marketer may use the best offer for the remainder of the offers provided to customers in the campaign. In the above example, if 50,000 customers are identified in the campaign and 8,200 test offers were sent, the remaining 41,800 customers can be sent the best offer.

Techniques of the invention allocate test offers by predicting that testing certain offers more than other offers will better advance the determination of a best offer with a desired confidence level. This is illustrated in the following example. In this example, the best offer is determined by comparing the confidence intervals of offer outcomes. For example, based on the outcomes of distributing offers in the initial iteration introduced above, the technique determines that 100 of the customers receiving offer A converted (i.e., 10%), 90 of the customers receiving offer B converted (i.e., 9%), and 30 of the customer receiving offer C converted (i.e., 3%). Moreover, based on the outcomes, the technique further determines that that the actual conversion rate of offer A for all customers will be between 9% and 11% with 95% certainty. Similarly, the technique determines that the actual conversion rate of offer B for all customers will be between 8% and 10% with 95% certainty. And, the technique determines that the actual conversion rate of offer C for all customers will be between 2% and 4% with 95% certainty. Because the confidence interval of the first place offer, offer A (9-11%), overlaps the confidence interval of the second place offer, offer B (8-10%), offer A cannot yet be determined to be the best offer with the desired confidence level, i.e., 95%. The technique iterates to perform more testing of the offers. The technique allocates test offers by predicting that testing certain offers (e.g., offers A and B) will advance the determination of a best offer with the desired confidence level more than testing other offers (e.g., offer C). More specifically, in the second iteration, the allocation of offers can be determined to most optimally reduce the size of the confidence intervals of the first and second place offers. By allocating more to the first and second place offers relative to other offers, the technique can identify a best offer with a desired confidence level using far fewer test offers than prior techniques. In the above three iteration example, the technique avoids sending 1800 (900+900) test offers that would otherwise have been sent if each iteration had simply allocated the offers evenly, i.e., 1000 to each offer in each iteration. Those 1800 customers can be sent the best offer (Offer A) rather than the worst offer (Offer C), which will likely improve the overall performance of the campaign.

Techniques of the invention are able to identify the best offer in a set of offers with a desired confidence level and using minimal testing of the offers. Accordingly, the techniques provide significant advantages over conventional hypothesis testing techniques which allocate tests evenly since can significantly reduce the amount of testing. Moreover, the techniques of the invention also provide advantages over multi-arm bandit techniques that do not identify best offers with a desired confidence level. The techniques of the invention more optimally allocate test offers to determine a best offer with a desired confidence level than prior techniques. A marketer is able to more quickly and accurately identify the best offer and use that offer for a greater percentage of the customers in the campaign. The techniques of the invention are particularly adventageous when more than two offers are being compared.

### Terminology

As used herein, the phrase “computing device” refers to any electronic component, machine, equipment, or system that can be instructed to carry out operations. Computing devices will typically, but not necessarily, include a processor that is communicatively coupled to a memory and that executes computer-executable program code and/or accesses information stored in memory or other storage. Examples of computing devices include, but are not limited to, desktop computers, laptop computers, server computers, tablets, telephones, mobile telephones, televisions, portable data assistant (PDA), e-readers, portable game units, smart watches, etc.

As used herein, the phrase “electronic content” refers to any content in an electronic communication such as a web page or e-mail accessed by, or made available to, one or more individuals through a computer network such as the Internet. Examples of electronic content include, but are not limited to, images, text, graphics, sound, and/or video incorporated into a web page, search engine result, or social media content on a social media app or web page.

As used herein, the phrase “customer” refers to any person who uses or who may someday use a computing device such as a computer, tablet, or cell phone to execute a web browser, use a search engine, use a social media application, or otherwise use the computing device to access electronic content via an electronic network such as the Internet. Accordingly, the phrase “customer” includes any person that data is collected about via electronic devices, in-store interactions, and any other electronic and real world sources. Some, but not necessarily all, customers access and interact with electronic content received through electronic networks such as the Internet. Some, but not necessarily all, customers access and interact with online ads and other offers received through electronic networks such as the Internet. Marketers send some customers online ads and other offers to advertise and promote products and services using electronic networks such as the Internet.

As used herein the phrase “marketer” refers to a person or entity that analyzes customer data, creates and sends online ads, and/or otherwise creates or implements a campaign to market or promote products or services to customers.

As used herein the term “campaign” refers to a series of activities that can include sending offers to customers to market one or more products or services to customers. Many, but not all, campaigns focus on a theme or objective such as promoting a particular feature of a product, introducing a new product, or establishing a particular image or slogan for a brand.

As used herein, the phrase “offer” refers to anything that encourages a particular outcome such that the success of the offer can be measured by the occurance or non-occurance of that outcome. Offers can be provided in electronic content, paper content, or any other appropriate form. One example of an offer is an ad sent in an e-mail, text message, or other electornic content to a customer that encourages the customer to watch a video, click on a link, purchase a product or service, or take another action. Another example of an offer is a banner ad place on a webpage to advertise a product and provide a link for more information about the product. Another example of an offer is a survey provided to customers requesting feedback.

As used herein, the phrase “outcome” refers to anything that is encouraged by an offer that can be measured or assessed as having occurred or not occurred. Outcomes can include any actions taken by a customer, results of automated processes, and/or analytically derived information about customer or process performance. Examples of outcomes include, but are not limited to, purchases of products or services, rentals of products, sales volumes of product sold or rented, clicks on links, time spent viewing a video or webpage, response time to an ad, or any other metric associated with a customer or process.

As used herein, the phrase “metric” refers to numeric information about one or more customers, but not limited to, age, income, number of computing devices, click-through rate, view-through rate, number of videos watched, conversion rate, revenue, revenue per thousand impressions (“RPM”), where revenue refers to any metric of interest that is trackable, e.g., measured in dollars, clicks, number of accounts opened and so on. Generally, metrics provide a numerical order, e.g., one revenue value is greater than another revenue value which is greater than a third revenue value and so on.

As used herein, the phrase “test offer” refers to an offer that is used to obtain outcome information used to assess offers relative to one another. For example, test offers of offer A and offer B can be used to determine which of the offers is a better offer. As another example, test offers of offers A-G can be used to determine which of the offers is the best offer.

As used herein, the phrase “best offer” refers to an offer that is determined based on some criteria or evaluation to be better than other offers which which it is being compared. A best offer can be determined with a confidence level, e.g., based on outcome information received so far, a process determines that offer A is the best offer with a 95% confidence level.

As used herein, the phrase “confidence level” refers to a measure of confidence in a conclusion. For example, based on outcome information received so far, a process determines that offer A is the best offer with a 95% confidence level, meaning that it is 95% likely that the offer is the best offer based on a statisitical analysis.

As used herein, the phrase “allocation” refers to the amounts or shares of something used for a particular purpose. For example, an allocation of test offers to offers in a set of offers determines how many test offers each of the offers in the set of offers will have. Such an allocation can result in distributing 1000 test offers using offer A, 800 test offers using offer B, 2000 test offers using offer C, etc.

As used herein, the phrase “unevenly” refers to, in an allocation, at least one amount or share of a particular purpose differing from at least one aother amount or share of another particular purpose. In other words, in constrast to an even allocation in which each amount or share in the allocation is the same, an uneven allocation involves at least one difference. For example, an uneven allocation is one that results in distributing 1000 test offers using offer A, 1000 test offers using offer B, and 999 test offers using offer C since at least one of the amounts is different.

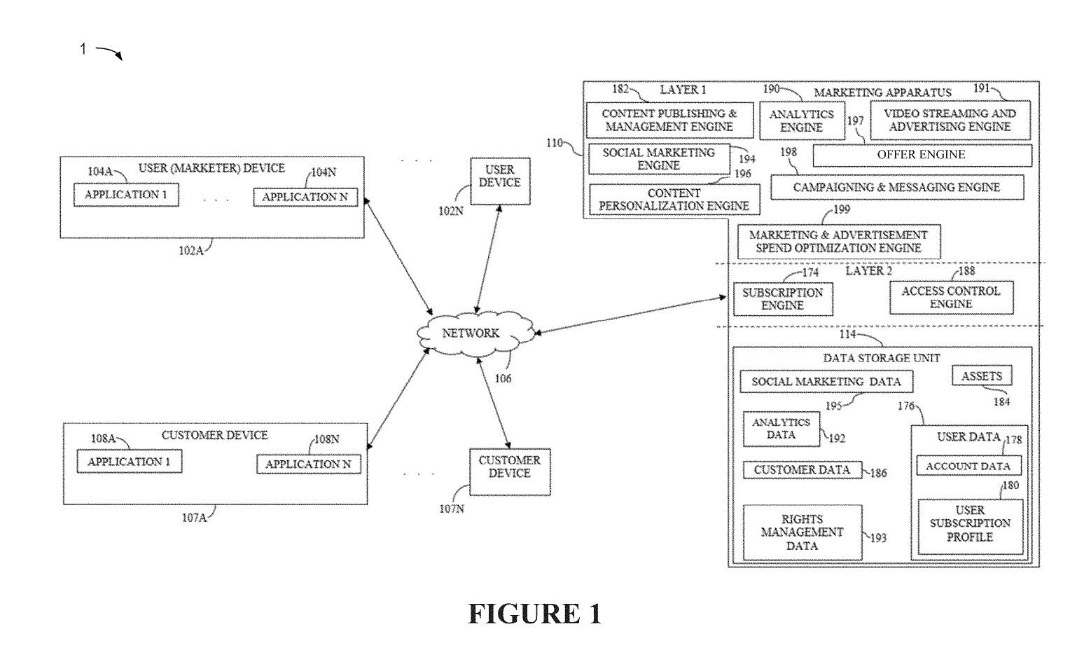

FIG. 1 illustrates an exemplary computer network environment 100 in which techniques for allocating test offers to determine a best offer in a set of offers with a desired confidence level. The environment 100 includes one or more user devices, such as user (marketer) device 102A up to a user device 102N having applications 104A-N. The environment 100 also includes one or more customer devices, such as customer device 107A up to a user device 107 N having applications 108A-N. Each of the user devices 102A-N and customer devices 107A-N is connected to a marketing apparatus 110 via a network 106 A user (marketer) uses various products, applications, or services supported by the marketing apparatus 110 via the network 106. A customer receives content from the marketing apparatus 110 and performs interactions that are tracked by the marketing apparatus 110.

Examples of users include, but are not limited to, marketing professionals who use marketing tools to generate, edit, track, or manage online content, or to manage online marketing process, customers, administrators, users who use document tools to create, edit, track, or manage documents, advertisers, publishers, developers, content owners, content managers, content creators, content viewers, content consumers, designers, editors, any combination of these users, or any other user who uses digital tools to create, edit, track, or manages digital experiences.

Digital tool, as described herein, includes a tool that is used for performing a function or a workflow electronically. Examples of the digital tool include, but are not limited to, content creation tool, content editing tool, content publishing tool, content tracking tool, content managing tool, content printing tool, content consumption tool, any combination of these tools, or any other tool that can be used for creating, editing, managing, generating, tracking, consuming or performing any other function or workflow related to content. Digital tools include the marketing apparatus 110.

Digital experience, as described herein, includes experience that can be consumed through an electronic device. Examples of the digital experience include content creating, content editing, content tracking, content publishing, content posting, content printing, content managing, content viewing, content consuming, any combination of these experiences, or any other workflow or function that can be performed related to content.

Examples of the network 106 include, but are not limited to, internet, local area network (LAN), wireless area network, wired area network, wide area network, and the like.

The marketing apparatus 110 includes one or more engines for providing one or more digital experiences. The marketing apparatus 110 can be implemented using one or more servers, one or more platforms with corresponding application programming interfaces, cloud infrastructure and the like. In addition, each engine can also be implemented using one or more servers, one or more platforms with corresponding application programming interfaces, cloud infrastructure and the like. The marketing apparatus 110 also includes a data storage unit 114. The data storage unit 114 can be implemented as one or more databases or one or more data servers. The data storage unit 114 includes data that is used by the engines of the marketing apparatus 110.

In one technique, the marketing apparatus 110 can be divided into two layers of engines, i.e. Layer 1 including core engines that provide workflows and Layer 2 including shared engines that are shared among the core engines. Any core engine can call any of the shared engines for execution of corresponding tasks. In another technique, the marketing apparatus 110 does not have layers and each core engine can have an instance of the shared engines. In either technique, each core engine can access the data storage unit 114 directly or through the shared engines.

The user of the user device 102A visits a webpage or an application store to explore applications supported by the marketing apparatus 110. The marketing apparatus 110 provides the applications as a software as a service (SaaS), or as a standalone application that can be installed on the user device 102A, or as a combination. The user creates an account with the marketing apparatus 110 by providing user details and also by creating login details. Alternatively, the marketing apparatus 110 can automatically create login details for the user in response to receipt of the user details. The user can also contact the entity offering the services of the marketing apparatus 110 and can get the account created through the entity. The user details are received by a subscription engine 174 and stored as user data 176 in the data storage unit 114. In some techniques, the user data 114 further includes account data 178 under which the user details are stored.

The user can opt for subscription of one or more engines of the marketing apparatus 110. Based on subscription details of the user, a user subscription profile 180 is generated by the subscription engine 174 and stored. The user subscription profile 180 is stored in the data storage unit 114 and indicates entitlement of the user to various products or services. The user subscription profile 180 also indicates type of subscription, i.e. premium subscription or regular subscription.

The marketing apparatus 110 includes a content publishing and management engine 182 that enables the user to create websites and other content. The content publishing and management engine 182 provides an end to end workflow to the user right from creation of content, to hosting of content, to publishing of content, and finally, to management, i.e. editing and republishing, of content. The content publishing and management 182 further includes one or more engines (not shown in FIG. 1), such as asset management engine, website management engine, mobile content management engine, form management engine, search engine and community management engine to enable one or more workflows. The user can create content, such as forms, mobile application or webpage content, using the content publishing and management engine 182. The user can either do the creation or can send it for creation to third party via workflows provided through the content publishing and management engine 182. The user then publishes the content and manages it through the content publishing and management engine 182. The user can also create communities or forums for discussions with customers (customers) and manage the communities through the content publishing and management engine 182. The content publishing and management engine 182 also provides asset management capabilities including asset searching using various tags and metadata. The content publishing and management engine 182 stores assets 184 in the data storage unit 114. Examples of the assets 182 include, but are not limited to, image, text, document, video, audio, font, and metadata. In addition, the content publishing and management engine 182 enables multisite, i.e. multiple websites and mobile content, management workflows, and commerce, i.e. personalized shopping experiences that incorporate video, social, and other dynamic media, related workflows.

Each engine of the marketing apparatus 110 also stores customer data 186 for the user in the data storage unit 114. The user or the entity of the user can have one or more customers 107A-N, including potential customers, and hence, the one or more engines of the marketing apparatus 110 store the customer data 186. The customer data 186 can be shared across these engines or can be specific to each engine. In some techniques, access data is a part of the customer data 186. Access to the customer data 186 is controlled by an access control engine 188 which can be shared across the engines of the marketing apparatus 110 or each engine can have one instance of the access control engine 188. The access control engine 188 determines if the user has access to a particular customer data 186 based on the subscription of the user and access rights of the user.

The marketing apparatus 110 also includes an analytics engine 190. The user can enable tracking of the content while creating the content or at any other point. Various methods of tracking can be used. For example, a tracking code can be embedded into the content for tracking and sending tracked data to the analytics engine 190. The analytics engine 190 tracks the data and stores tracked data as analytics data 192. The analytics engine 190 tracks the data and performs meaningful processing of the analytics data 192 to provide various reports to the user. In addition, in one technique, the analytics engine 190 also acts as a shared engine and is accessible by other engines to obtain meaningful analysis on basis of which other engines can offer various functionalities to the user. In another technique, each engine can have an instance of the analytics engine 190 which is customized according to need of that engine. The analytics engine 190 is used for tracking all types of content, such as mobile application, video, image, website, document, advertisement, and also for tracking the assets 184. The analytics engine 190 also supports predictive intelligence to provide predictions based on the analytics data 192. The analytics engine 190 also stitches information tracked from various sources where the content is consumed and provides a holistic view, i.e. 360 degrees' view of the analytics data 192. The analytics engine 190 can be used to track outcomes of offers provided to customers using customer devices 107A-N.

The marketing apparatus 110 also includes a social marketing engine 194 for providing social marketing related workflows. The social marketing engine 194 allows the user to share the content on social networks, and then manage the content sharing and associated information, such as posts and comments. For example, the social marketing engine 194 provides recommendations to the user to determine when to post which content and to determine how an audience will react to the post, helps the user to respond to queries from viewers of post, and performs other managing related to the post. In addition to the social networks, the social marketing engine 194 also provides workflows to manage content on blogs, and other communities. The social marketing engine 194 provides recommendations by tracking the data on social networks and storing the data as social marketing data 195. The social marketing data 195 is then processed by the social marketing engine 194 to determine recommendations. The social marketing engine 194 can automate many manual workflows. For example, the social marketing engine 194 can perform automatic posting of the post at an appropriate time, automatically respond to queries from post viewers and the like. The social marketing engine 194 uses the analytics engine 190 for tracking data on social networks or can source data from the social networks. The social marketing engine 194 can also be a shared engine which can be accessed by various engines of the marketing apparatus 110. Alternatively, the engines can have an instance of the social marketing engine 194 and can directly access the social marketing data 195.

The marketing apparatus 110 also includes a content personalization engine 196. The content personalization engine 196 enables the user to provide different digital experiences to the customers when different customers visit the same webpage or same application of the user. The content personalization engine 196 provides various workflows to the user to create different versions of the webpage or the application or the content and to perform AB testing. Based on the testing, the user may choose to provide different personalization for different sets of customers. The content personalization engine 196 also uses the customer data 186 which can be part of the analytics data 192, in one technique, or can be stored separately in another technique. The customer data 186 includes customer profiles. The customers, as described herein, also includes mere visitors which are not customers yet. A profile includes one or more attributes of a customer. An attribute, as described herein, is a concept that can be used segment the customers, for example, using a rule. Examples of the attribute include, but are not limited to, geographical location, age, gender, purchase capacity, language, habits, browsing trends, or any other attribute using which the customers can be segmented.

The customer data 186 is generated by collecting data from different sources including electronic sources, such as the analytics engine 190, online forms, customer submitting data online, and other online sources, and non-electronic sources including paper forms and other offline sources. The customer data 186 can be shared between users and some of the customer data 186 can be specific to each user and not accessible by other users. The customer segments are used by the content personalization engine 196 to personalize content and show relevant content to the customers. In addition, the content personalization engine 196 provides automated workflows to enable the personalization including providing recommendations for the content that should be shown to a particular customer segment.

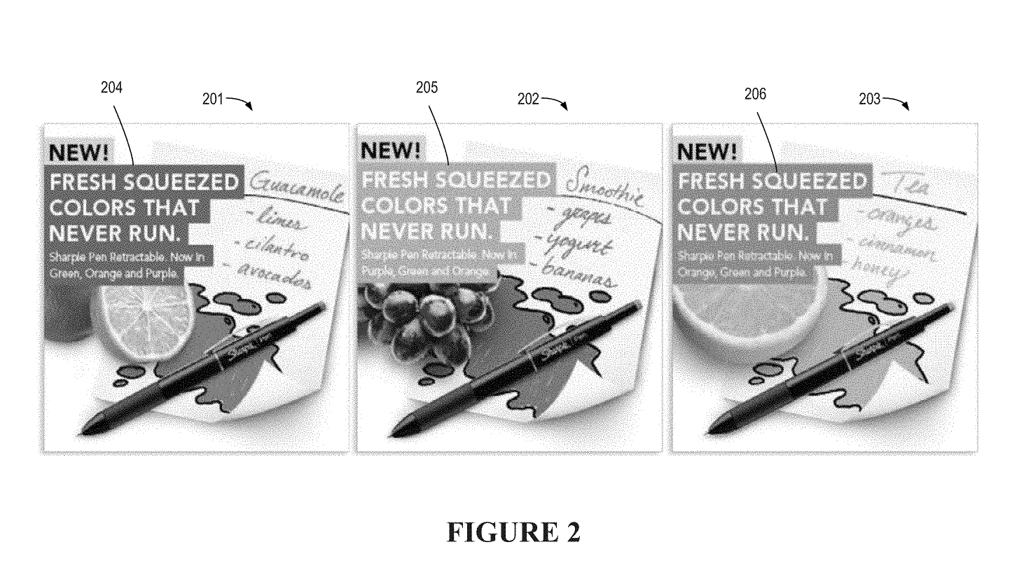

The marketing apparatus 110 further includes an offer engine 197 that enables distribution of offers (including test offers) to customers, analysis of outcomes of test offers, allocation of test offers to particular offers in a set of offers, and determinations of best offers within sets of offers. Examples of techniques for performing these functions are described herein, for example, with respect to FIGS. 2-8. Techniques of the invention for allocating test offers to determine a best offer in a set of offers with a desired confidence level can be performed by offer engine 197 or by any other engine of the marketing apparatus 110.

The marketing apparatus 110 also includes a campaigning and messaging engine 198 that enables workflows for the user to perform campaigns including sending marketing emails. The campaigning and messaging engine 198 uses the customer data 186 and generates customer segments for performing campaigns. Alternatively, the campaigning and messaging engine 198 uses customer segmentation engine 197 for generating customer segments.

The campaigning and messaging engine 198 also stores different customer segments for each user in the customer data 186. In addition, the content used for creating personalized messages, email identifiers and other data is stored as part of the customer data 186 which can be specific for the user and inaccessible to other users.

The marketing apparatus 110 also includes marketing and advertisement spend optimization engine 199. The marketing and advertisement spend optimization engine 199 helps the user in budget management for running campaigns, showing advertisements on websites, as search results, social advertisements, and other form of advertising. The marketing and advertisement spend optimization engine 199 tracks budget spend of the user and the budget remaining, and based on that performs analysis to recommend advertising channels for maximizing benefit. In addition, the marketing and advertisement spend optimization engine 199 uses the customer data 186 and the analytics data 192, and stitches that data to generate the recommendation. The analytics data 192 includes information on how the marketing content performed. The customer data 186 further indicates what type of customers visited the marketing content and the analytics data 192 further indicates who among those customers ended up in performing a transaction.

The marketing apparatus 110 also includes a video streaming and advertising engine 191 that helps the user, such as broadcasters, cable networks and service providers, create and monetize engaging and personalized viewing experiences. The video streaming and advertising engine 191 can be implemented to provide a software development kit to the user to build and deliver videos to the customers. In addition, the video streaming and advertising engine 191 provides workflows to the user to insert advertisement within the videos and provides recommendations to the user for locations for advertisement insertion. The recommendations are generated using the analytics data 192 which includes information regarding what portions of video was viewed most and other video analytics data, and also using the customer data 186 which includes customer segments who viewed the video and corresponding advertisement. The video streaming and advertising engine 191 also stores rights management data 193 for different videos for the customers of the user. For example, if a video is paid then the video streaming and advertising engine 191 does not provide access to the customer based on the rights management data 193. Using the rights management data 193, the video streaming and advertising engine 191 protects content rights across various devices of the customers. Also, the video streaming and advertising engine 191 includes an authentication engine for authenticating the customers. The customer authentication data can also be stored as part of the customer data 186. The customer authentication data includes login details or other identifiers for the customer.

FIG. 2 illustrates graphical depictions of several alternative offers 201, 202, 203 to be compared with one another. In this example, a marketer is considering which of the three offers 201, 202, 203 to provide to customers in a campaign. The offers 201, 202, 203 differ from one another in various ways. For example, the first offer 201 uses a purple background 204 behind the text phrase “FRESH SQUEEZED COLORS THAT NEVER RUN. Sharpie Pen Retractable. Now in Green, Orange, and Purple,” the second offer 202 uses an orange background 205 behind the text phrase “FRESH SQUEEZED COLORS THAT NEVER RUN. Sharpie Pen Retractable. Now in Purple, Green, and Orange,” and the third offer 203 uses a green background 206 behind the text phrase “FRESH SQUEEZED COLORS THAT NEVER RUN. Sharpie Pen Retractable. Now in Orange, Green, and Purple.” After creating a set of offers, the marketer then uses techniques disclosed herein to identify which of the offers is the best offer.

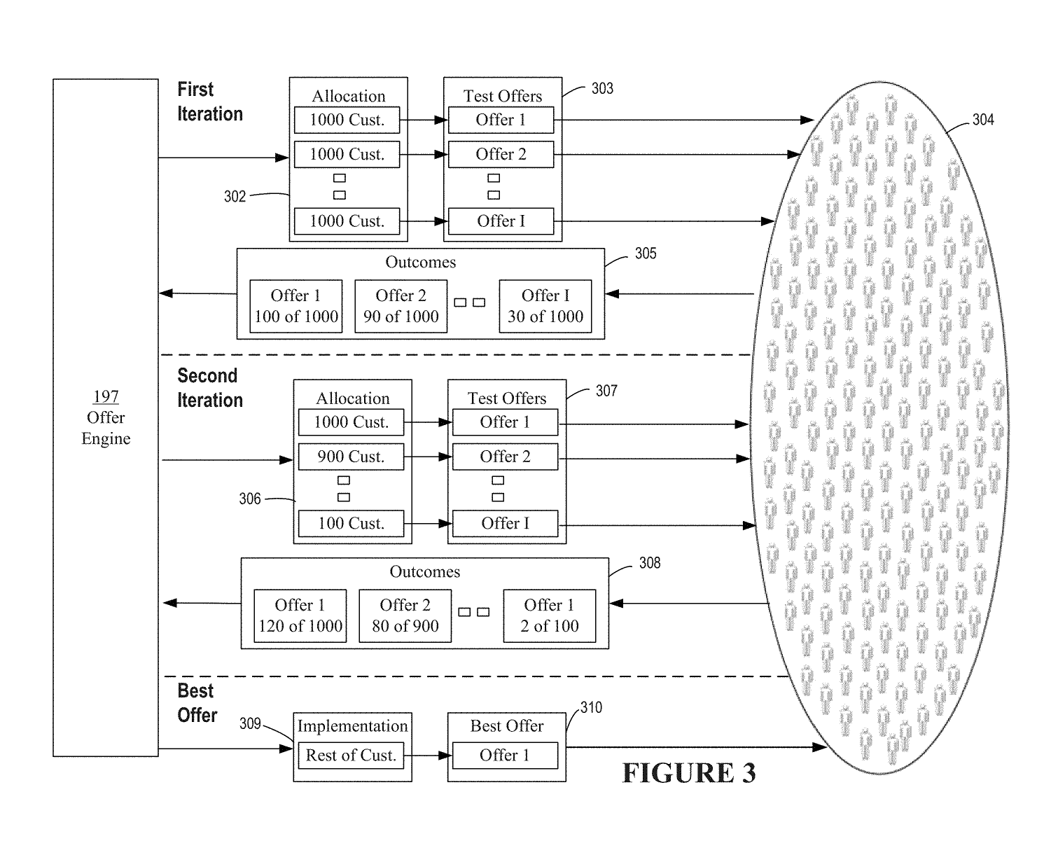

FIG. 3 is a block diagram illustrating an exemplary process allocating test offers to determine a best offer in a set of offers. In this example, an offer engine 197 is used to distribute and assess offers to customers 304 in a campaign. In a first iteration, the offer engine 197 determines an initial allocation 302, allocating test offers 303 evenly to each of the offers in the set of offers. In this example, 1000 of the customers 304 receive offer 1, 1000 of the customers 304 receive offer 2, 1000 of the customers 304 receive offer 1, etc.

The outcomes 305 of these test offers 303 are tracked and assessed by the offer engine 197. In this example, a desired outcome (e.g. a purchase, a click, etc.) occurred 100 times for the customers receiving offer 1, 90 times for the customers receiving offer 2, 30 times for the customers receiving offer 1, etc. Based on the outcomes 305, offer 1 is the first place offer and offer 2 is the second place offer. However, it remains unknown whether offer 1 is the best offer since there is uncertainty whether the results from the test data are statistical anamolies or will apply to the entire population of customers 304.

Accorrdingly, offer engine 197 can determine whether the initial outcomes 305 provide a sufficient level of confidence that the first place offer is the best offer. For example, based on a statistical analysis of the outcomes 305, the offer engine determines that there is a 98% confidence level that offer 1 is the best offer, the offer engine can compare this with a threshold (e.g., 95%) and determine to use that offer as the offer in the marketing campaign.

However, in this example of FIG. 3, the offer engine 197 determines that the confidence level that the first place offer is the best offer is insufficient and thus determines to continue testing the offers to determine the best offer with greater confidence. In particular, the offer engine 197 determines an allocation 306 of offers for the second iteration of testing. The allocation of offers is specifically determined to unevenly test some of the offers more than other of the offers. This uneven testing is designed to result in outcomes that allow the confidence level in a best offer to achieve a desired confidence level (e.g., 95%) with the fewer number of test offers than evenly testing the offers. For example, if 10 offers are being tested, relatively few customers can be provided the lowest performing offers in the second iteration. These offers are unlikely to be the test offer and further testing of these offers may not improve the confidence level in a best offer as much as testing better performing offers. The allocation 306, however, can ensure that at least some customers receive low performing offers to ensure that their low performance was not a statistical anamoly.

In the example of FIG. 3, the offer engine 197 determines an allocation 306 that allocates 1000 customers to receive offer 1 (the first place offer) and 900 customers to receive offer 2 (the second place offer), and 100 customers to receive each of the other offers in the set of offers. Based on the allocation 306, test offers 307 are sent to groups of the customers 304.

The outcomes 308 of these test offers 307 are tracked and assessed by the offer engine 197. In this example, a desired outcome (e.g. a purchase, a click, etc.) occurred 120 times for the customers receiving offer 1, 80 times for the customers receiving offer 2, 2 times for the customers receiving offer 1, etc. Based on the outcomes 305, offer 1 continues to be the first place offer and offer 2 continues to be the second place offer. However, it remains unknown whether offer 1 is the best offer since there is still uncertainty whether the results from the test data are statistical anamolies or will apply to the entire population of customers 304. There will always be some uncertainty since the entire population of customers 304 cannot be tested for every offer. However, in this example, the offer engine 197 is able to determine that the first place offer is the best offer with a sufficient confidence level (e.g., greater than 95%), to proceed with using the offer in the campaign. Accordingly, the offer engine 197 next determines an implementation 309 that provides the best offer 310 to the rest of the customers 304.

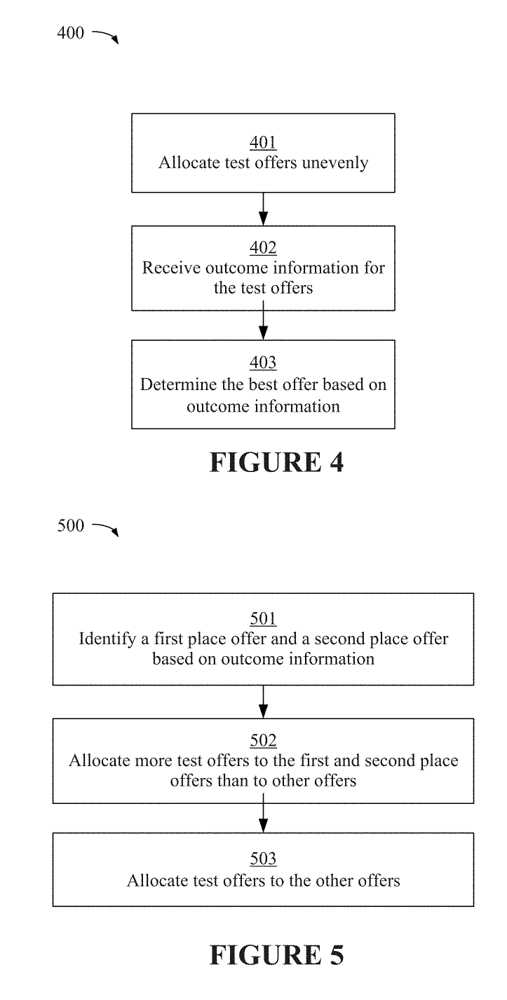

FIG. 4 is a flow chart illustrating an exemplary technique 400 allocating test offers to determine a best offer in a set of offers with a desired confidence level. The functions involved in this example generally involve allocating test offers unevenly, as shown in block 401, receiving outcome information for the test offers, as shown in block 402, and determining a best offer based on this outcome information, as showing in block 403. The functions performed in technique 400 are generally implemented on one or more computing devices that use one or more processors to execute algorithms of one or more operations defined in stored instructions. For example, exemplary technique 400 can be performed by one or more processors of one or more computing devices such as by offer engine 197 of FIGS. 1 and 2. Software code for performing the functions of technique 400 can be stored on a non-transitory computer readable medium and executed by one or more processors. The operations of various exemplary algorithms that can be employed to perform these functions are discussed in the FIGURES and throughout this specification.

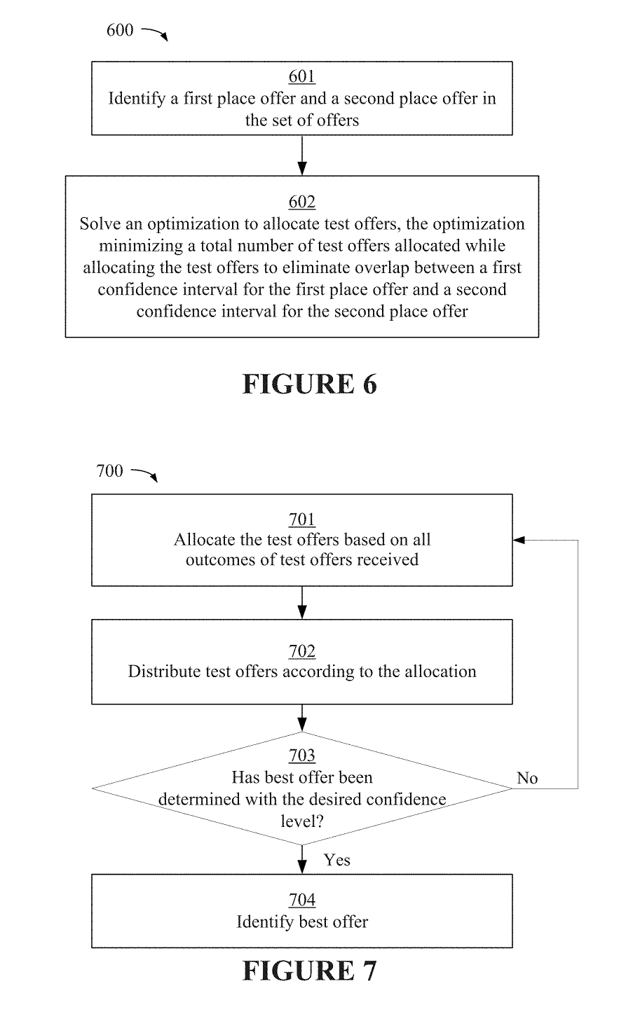

The function of allocating test offers unevenly of block 401 can be performed using various algorithms. The algorithms can include any of the exemplary techniques disclosed herein as well as modifications to the techniques herein to address particular circumstances of an implementation. One exemplary algorithm allocates test offers in a set of test offers to attain a desired confidence level in a best offer for a campaign. For example, this can involve determining an allocation that allocates relatively more test offers for one or more of the offers that are expected to be candidates for the best offer and allocating relatively fewer test offers for the other offers. FIGS. 5 and 6 provide additional examples of algorithms or processes that can be used to allocate test offers unevenly.

FIG. 5 is a flow chart illustrating an exemplary technique 500 for allocating test offers. Exemplary technique 500 can be performed by one or more processors of one or more computing devices such as by offer engine 197 of FIGS. 1 and 2. Software code for performing the operations of technique 500 can be stored on a non-transitory computer readable medium and executed by one or more processors.

Technique 500 involves identifying a first place offer and a second place offer based on outcome information, as shown in block 501. The outcome information can come from prior test offers. For example, one or more prior iterations of an iterative process may have provided outcome information from customers who were sent the various offers in a set of offers. Identifying the first and second place offers can involve comparing or otherwise analyzing the outcome information to identify which of the offers in the set of offers has performed best with respect to a desired outcome metric or criteria. For example, a marketer can identify that maximum conversions per offer is the desired outcome. In this example, the technique analyzes the outcome information, determines a percentage or value representing the conversions per offer of each of the offers (e.g., offer 1 has 10% conversion, offer 2 has 12% conversion, etc.), and identifies the first and second place offers having the highest conversions per offer. In another example, the marketer can identify that click through rate (i.e., clicks per offer) is the desired outcome. In this example, the technique analyzes the outcome information, determines a number of clicks per offer for each of the offers (e.g., offer 1 has 22% click through rate, offer 2 has 5% click through rate, etc.), and identifies the first and second place offers having the highest click through rates.

Technique 500 allocates more test offers to the first and second place offers than to other offers, as shown in block 502, and allocate test offers to the other offers as shown in block 503. In one example, more test offers are allocated to each of the first and second place offers than to each of the other offers. For example, in a set of 10 offers the top two offers can each be allocated 1000 test offers and the remaining 8 offers can each be allocated 100 offers. In another example, the first and second place offers are given relatively more offers by gradually decreasing the offer based on how well the offers performed in testing. For example, in a set of 6 offers, the first place offer can be allocated 1000 test offers, the second place offer can be allocated 900 test offers, the third place offer can be allocated 800 offers, the fourth place offer can be allocated 600 offers, the fifth place offer can be allocated 400 offers, and the sixth place offer can be allocated 200 offers. In these examples, the allocation favors the better performing offers and is less likely to waste test offers on offers that are unlikely to be the best offer.

Allocating test offers to other offers (e.g., one or more of the offers that are not the first and second place offers) can, but does not necessarily involve ensuring that each offer receives at least some test offers. This can ensure that early iterations in an iterative process do not exclude an offer from being considered as a best offer based on a statistical anomoly in early iterations of testings. As the iterations continue and the confidence level in offer performance increases, the allocations to other offers can be decreased. In one example, an exploration weight is used to weight the amount of test offers allocated to other offers based on the progress of an iterative testing process. As the process continues, the exploration weight is decreased so that fewer and fewer test offers are allocated to the other offers respectively.

FIG. 6 is a flow chart illustrating an exemplary technique 600 allocating test that minimizes the number of test offers used to obtain a desired level of confidence. Exemplary technique 600 can be performed by one or more processors of one or more computing devices such as by offer engine 197 of FIGS. 1 and 2. Software code for performing the operations of technique 600 can be stored on a non-transitory computer readable medium and executed by one or more processors. Technique 600 involves identifying a first place offer and a second place offer based on outcome information, as shown in block 601. This can be performed in a similar manner as block 501 of FIG. 5.

Technique 600 further involves solving an optimization to allocate test offers, as shown in block 602. Specifically, the optimization minimizes a total number of test offers allocated, while allocating the test offers to eliminate overlap between a first confidence interval for the first place offer and a second confidence interval for the second place offer.

The following algorithm provides examples of an optimization used to allocate test offers. Let k be the total number of options and let (p₁, p₂, . . . , pₖ) denote the vector of true means. Suppose that the response (e.g., conversion) of a customer to option i, is a random sample from a binomial distribution with parameter pᵢ. The winner of the test (e.g., the best offer) is the option with the highest mean, i.e argmaxᵢ pᵢ. However, since the true means is unknown, experiment to estimate these numbers is needed. Assume that N is the total number of customers that are allocated for experimentation. The aim is finding the smallest possible value of N for which the winner mean is significantly higher than the others. This is measured using the difference between the confidence intervals. Let Nᵢ denote the total number of samples allocated to option i, so that Σᵢ₌₁^{k} Nᵢ=N and let Xᵢ¹, Xᵢ², . . . , Xᵢ^{Ni} denote the 0,1 conversion rates of samples allocated to option i. The α-level confidence interval for the mean of option i is constructed as:

$$[ {L}_{i} , {U}_{i} ] = [ {\hat{p}}_{i} - α \sqrt{\frac{{\hat{p}}_{i} ( 1 - {\hat{p}}_{i} )}{{N}_{i}}} , {\hat{p}}_{i} + α \sqrt{\frac{{\hat{p}}_{i} ( 1 - {\hat{p}}_{i} )}{{N}_{i}}} ]$$

Where the mean of the sample i (e.g., the mean of the outcome of each test offer) \hat{p}ᵢ=1/N ΣᵢXᵢ^{j} and α comes from the tail of the t-student distribution with Nᵢ−1 degrees of freedom. This confidence set is based on the fact that:

$$T = \frac{{\hat{p}}_{i} - {p}_{i}}{\sqrt{\frac{{\hat{p}}_{i} ( 1 - {\hat{p}}_{i} )}{{N}_{i}}}}$$

is distributed according to the Nᵢ−1 degrees of freedom t student distribution. The value of α adjusts the probability of falling outside the interval. For example, 95 percent coverage requires α approximately equal to 1.96. Thus equation 1 provides a confidence interval for the mean of the sample i (e.g., the mean of the outcome of each test offer) with a specified confidence level.

These confidence intervals are used in an algorithm for allocation of N samples (e.g., test offers) among different options (e.g., offers) to try to find the best option (e.g., the best offer) using the fewest total samples (e.g., test offers). After drawing M samples (e.g., test offer outcomes) with M<<N, the options (e.g., offers) are ordered based on their empirical mean with respect to a desired outcome, \hat{p}₁≤\hat{p}₂≤ . . . ≤\hat{p}ₖ.

The optimization is performed to allocate the remaining samples (e.g., test offers) so that after N samples (e.g., test offers) the highest statistical guarantee of winning for the option k is achieved. The optimization problem is formulated as follows:

minimize Lₖ−maxᵢ₌₁^{k-1}Uᵢ.

subject to. Σᵢ₌₁^{k}Nᵢ=N

with the variables N₁, N₂, . . . , Nₖ. This is convex and can thus be solved efficiently and quickly. Knowing optimal values for Ni and knowing how many samples (e.g., test offer outcomes) have been drawn on the first M samples (e.g., test offers) for each of k different options (e.g., offers), the technique picks the next sample with a probability proportional to the difference between them. Thus, after solving the above optimization problem, the optimal number of samples needed for offer i given by Nᵢ is known. It is also known how many of among the first M samples were allocated to offer i. The difference shows how many test offers for offer i are needed to reach Nᵢ test offers for offer i, as suggested by the optimization problem. The new test offers are allocated to offer i with a probability proportional to this number, i.e., this number divided by N-M (number of total remaining test offers among all different offers). This helps achieve a high statistical guarantee after drawing all N samples.

Solving the above minimization results in finding an optimal allocation of samples, e.g., test offers, to attain a desired confidence level that one of the offers is the best offer for the campaign. It effectively finds an allocation that uses the smallest number of samples N that is expected to achieve the desired level of confidence in the best option. For example, solving the equation can determine that allocating X test offers to offer 1, Y offers to offer 2, Z offers to offer 3, etc. will likely lead to finding a best options with the desired confidence level with the smallest use of test offers, e.g., where X+Y+Z . . . is the smallest.

Note that there are some practical issues with this approach. First, during experimentation, the highest mean is not always fixed and in many scenarios it changes over the course of multiple testing iterations. Second, if the optimization problem is solved only once, then the error in estimation of \hat{p}ⁱ might not become small even after all N iterations. These issues can be addressed in various ways. In one example, these issues are addressed by solving the optimization problem at each iteration of an iterative testing process. For example, the optimization problem can be solved after each iteration, for example, to reallocate the test offers to the offers in the set of offers.

A third practical issue is that in many practical scenarios, N is unknown. And, if the optimal value of the optimization problem is negative, it implies that more than N samples may be needed to separate the confidence interval of the best offer from the other offers. This issue can be addressed in various ways. In one example, the technique assumes some value for N and update this value during the experimentation. For instance, this can involve doubling N whenever the total number of drawn samples is close to N.

A fourth practical issues is that many implementations will involve small values for the desired outcomes (e.g., really small conversion rates). Thus, in practice a relatively large number of samples from each distribution may be needed to provide accurate estimates. This issue can be addressed in various ways. In one example, an exploration weight, as described above, can be used to address this issue. A small amount of exploration is performed by giving weights to options with fewer samples (e.g., test offer outcomes) so that the next sample is drawn from them with a higher probability. This also adds some randomness.

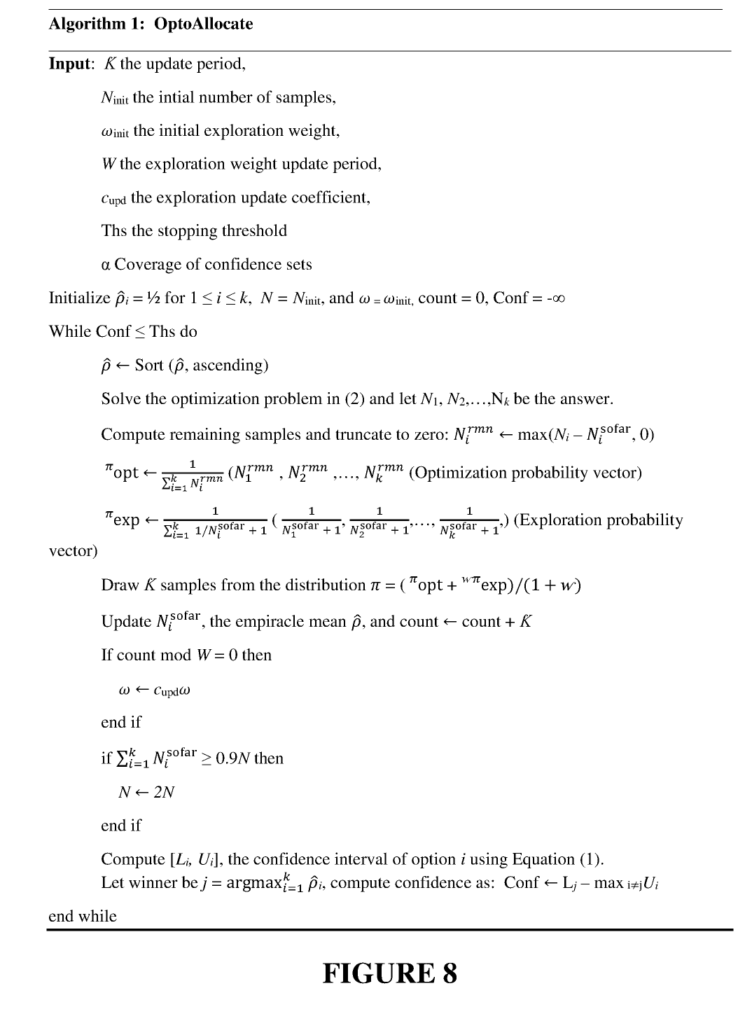

The algorithm 700 of FIG. 8 described below addresses these four issues. Note however, that techniques of the invention can involve alterantive steps to address these issues and/or otherwise perform an optimization to allocate test offers without specifically addressing one or more of these practical issues.

Returning to FIG. 4, after allocating the test offers unevenly and distributing the test offers, the technique 400 receives outcome information for th test offers, as shown in block 402. The function of receiving outcome information for the test offers of block 402 can be performed using various algorithms. For example, this can involve tracking customer actions, performance statistics, or another metric using an analytics system. Customer actions, e.g., making purchases, clicking on links, and other actions taken on a computer can be tracked using software applications that identify the user action, associate the user action with the test offer, and then provide information about the user action and the test offer to an analytics system. Outcome information can additionally or alternatively be received from a customer directly, for example, based on a customer providing responses in a survey. Outcome information can also be determined based on information received from systems that provide content to customers. For example, the length of time that customers view a video after receiving an offer can be tracked by the server that streams or otherwise provides the video to the customers. Numerous other techniques can be used to identify a desired outcome, associate that outcome with an offer, and provide the information or analysis and use.

In FIG. 4, after receiving the outcome information for the test offers, the technique 400 determines the best offer based on the outcome information, as shown in block 403. The function of determining the best offer based on the outcome information can involve various algorithms. For example, to identify the best offer with a desired confidence level, confidence intervals for the first and second place offers can be compared. If the confidence intervals do not overlap, then the technique can determine that the first place offer is the best offer with a confidence level based on the confidence levels of the confidence intervals. As a specific example, if there is a 95% chance that the mean of actual outcomes for a first place offer will be within an interval 9.0-10.0 and 95% chance that mean of actual outcomes for a second place offer will be within an interval 8.0-8.9, based on these intervals not overlapping with one another, the technique 400 can conclude that the first place offer is the best offer with a 95% confidence level.

FIG. 7 is a flow chart illustrating an exemplary iterative technique 700 allocating test offers. Exemplary technique 700 can be performed by one or more processors of one or more computing devices such as by offer engine 197 of FIGS. 1 and 2. Software code for performing the operations of technique 700 can be stored on a non-transitory computer readable medium and executed by one or more processors.

The technique 700 involves allocating test offers based on all outcomes of test offers received, as shown in block 701. In the initial iteration in which no test offers outcomes are available, the technique can allocate test offers evenly or based on any other appropriate criteria. In later iterations, the allocation is based on the outcomes of the test offers received so far. Thus, as each iteration, the technique 700 has more and more information upon which the allocation can be determined.

The technique 700 involves allocating test offers according to the allocation, as shown in block 702. Thus, at each iteration, test offers are distributed according to the reallocation. Outcomes of the test offers are received and used to evaluate the offers. In block 703, the technique 700 determines if the best offer has been determined with the desired level of confidence. If not, then the technique returns to block 701 to allocate additional test offers based on the outcomes of the test offers received. This iterative process of blocks 701, 702, 703 continues until, in block 703, the technique 700 determines that the best offer has been determined with the desired confidence level. In block 704, the technique 700 identifies the best offer. The best offer can then be used for the remaining customers in the campaign or for any other purpose.

FIG. 8 is a graphic illustrating steps of an exemplary technique 800 allocating test offers to determine a best offer in a set of offers with a desired confidence level. In technique 800, the inputs include the update period K, the intitial number of samples, Nᵢₙᵢₜ, the initial exploration weight wᵢₙᵢₜ, the exploration weight update period W, the exploration weight coefficient c_{upd}, the stopping threshold Ths, and the coverage of the confidence sets α.

The technique 800 initializes the initial means \hat{p}ᵢ to be ½ for each of the options for each of the options i. The initial exploration weight wᵢₙᵢₜ, used to set the exploration weight for the first iteration is also set. The count is set to 0 and the confidence level is set to negative infinity. The exploration update coefficient can also be initialized, for example, to 1.

The technique 800 then performs the iterations using a while loop that iterates as long as the confidence level, Conf, is less than the stopping threshold, Ths. The stopping threshold, Ths, provides the desired confidence level. If the confidence level, Conf, that the first place option is the best option is less than the stopping threshold, Ths, then the while statement continues to loop.

The technique 800 sorts the means of the options \hat{p}ᵢ in an ascending order. In the initial iteration, the means are all initialized to ½ as noted above. In subsequent iterations, the means will differ based on the outcome information that is received from the samples (e.g., the outcomes of the test offers). The algorithm next determines an allocation by solving an optimizing such as the optimization described with respect to FIG. 6. Solving this optimization allocates samples to options (e.g., allocating test offers to offers in a set of offers).

The technique 800 computes the remaining samples and truncates to zero. Thus if 100 samples are distributed in the first iteration, the technique 800 will determine a new allocation of Nᵢ numbers. However, some of those will have already been used in the first iteration. Thus, this step adjusts how many will be distributed in the current iteration by accounting for the samples already distributed in prior iterations. The technique 800 determines an optimization probability vector and an exploration probability vector and draws K samples from the distribution of the mean using the exploration weight w. \hat{p}exp is used to change the exploration weights for options that may not have gotten enough allocations. Thus, at each iteration, the distributions associated with the options are updated. In short, these probability vector equations \hat{p}ᵢ update values while taking into account the exploration weight w to ensure that options are not overlooked due to a statistical anamoly. More specificatlly, at each iteration (each update), there are two probability vectors. The exploration vector, 1-\hat{p}ₑₓₚ, weighs different offers proportional to 1/Nᵢ, so that those offers that have not received enough test offers (samples) get higher weights. This helps in estimating those options that have not received enough allocation (which might lead to a high error in estimating their mean parameter) better. The optimization vector, 2-\hat{p}ₑₓₚ, weighs according to the solution of the optimization problem, considering the subtraction of the samples allocated so far. This essentially is the optimal allocation, once the estimations are accurate enough.

These two vectors are combined with the first one having its weight as w and the second one having its coefficient as 1. More exploration is generally needed in the beginning of the process, so the process sets w=1 and then it is annealed by the rate c_{upd} each time that count is divisible by W, so as to allow a fair amount of exploration in the beginning of experiment (to improve our estimations) and move towards the best optimal allocation as the experiment goes on (to reach to the conclusion faster).

The exemplary technique 800 updates the Nᵢ so far, the empirical mean \hat{p}ᵢ, and the count by adding the update period K to the count. If the exploration weight update period, W, has occurred, i.e., if count mod W is equal to zero, then the exploration weight, w, is updated by multiplying the exploration weight, w, by the c_{upd}. In one example, c_{upd} is initially 1 and then 0.5 for subsequent iterations. The result is that the exploration weight, w, is reduced as the technique 800 continues to iterate.

The technique 800 updates N in appropriate circumstances. In this example, if the sum of Ni so far is greater than or equal to 0.9N then N is doubled. In other words if the number of samples so far is at 90% or more then the number of samples N is doubled. This ensures that the technique 800 will have sufficient samples available to reach the desired confidence level.

The technique 800 then computes the lower and upper bounds of confidence intervals for all options i and determines a winner (e.g., first place offer) by identifying the offer j with the maximum mean. The technique 800 further computes a confidence level in the first place offer, j, being the best offer using the lower bounds of the offer j's confidence interval and the maximum upper bounds of any of the other offers' confidence intervals. In one example, the equation Conf→Lⱼ−max_{i≠j} Uᵢ provides a measure which shows whether the confidence intervals have become nonoverlapping or not. Basically, this number being positive means that the the given confidence level is achieved, while this number being negative implies that the desired confidence level has not been achieved yet and additional testing will continue.

Technique 800 is provided herein as an example of an algorithm that iteratively uses samples (e.g., test offers) to evaluate options (e.g., offers) to determine a best option (e.g., best offer) with a desired level of confidence. While the techniques of this example and those generally discussed in this application have been discussed in the context of evaluating offers, the techniques disclosed herein are applicable to other types of options. For example, the techniques could be used to compare several computational process options to determine which of the process options is the fastest. The outcomes thus do not have to be customer or even human initiated actions, but instead can be outcomes associated with automated processes. The techniques apply offers that encourage a particular customer action as the outcome, offers that do not request customer actions, as well as to a variety of other types of options.

### Exemplary Computing Environment

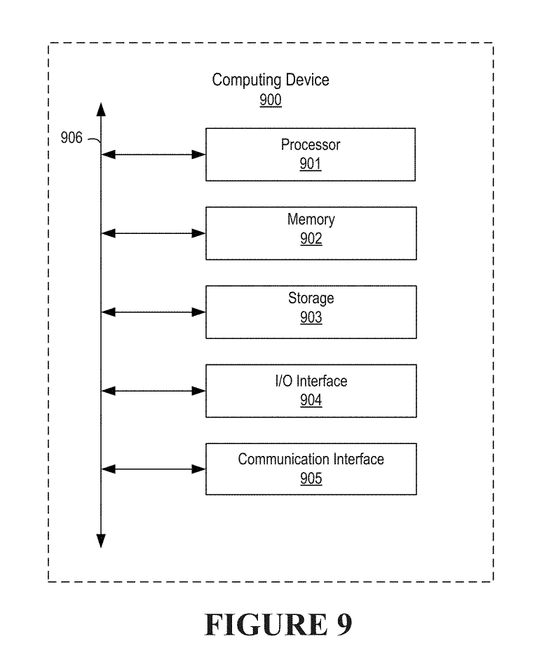

Any suitable computing system or group of computing systems can be used to implement the techniques and methods disclosed herein. For example, FIG. 9 is a block diagram depicting examples of implementations of such components. The computing device 90 can include a processor 901 that is communicatively coupled to a memory 902 and that executes computer-executable program code and/or accesses information stored in memory 902 or storage 903. The processor 901 may comprise a microprocessor, an application-specific integrated circuit (“ASIC”), a state machine, or other processing device. The processor 901 can include one processing device or more than one processing device. Such a processor can include or may be in communication with a computer-readable medium storing instructions that, when executed by the processor 901, cause the processor to perform the operations described herein.

The memory 902 and storage 903 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 900 may also comprise a number of external or internal devices such as input or output devices. For example, the computing device is shown with an input/output (“I/O”) interface 904 that can receive input from input devices or provide output to output devices. A communication interface 905 may also be included in the computing device 900 and can include any device or group of devices suitable for establishing a wired or wireless data connection to one or more data networks. Non-limiting examples of the communication interface 905 include an Ethernet network adapter, a modem, and/or the like. The computing device 900 can transmit messages as electronic or optical signals via the communication interface 905. A bus 906 can also be included to communicatively couple one or more components of the computing device 900.

The computing device 900 can execute program code that configures the processor 901 to perform one or more of the operations described above. The program code can include one or more modules. The program code may be resident in the memory 902, storage 903, or any suitable computer-readable medium and may be executed by the processor 901 or any other suitable processor. In some Techniques, modules can be resident in the memory 902. In additional or alternative Techniques, one or more modules can be resident in a memory that is accessible via a data network, such as a memory accessible to a cloud service.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure the claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more Techniques of the present subject matter. Any suitable programming, scripting, or other type of language or combinations of languages may be used to implement the teachings contained herein in software to be used in programming or configuring a computing device.

Techniques of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific Techniques thereof, it will be appreciated that those skilled in the art, upon attaining an understanding of the foregoing, may readily produce alterations to, variations of, and equivalents to such Techniques. Accordingly, it should be understood that the present disclosure has been presented for purposes of example rather than limitation, and does not preclude inclusion of such modifications, variations, and/or additions to the present subject matter as would be readily apparent to one of ordinary skill in the art.

What is claimed is:

1. A method, performed by a computing device, for allocating test offers to determine a best offer in a set of offers with a desired confidence level, the method comprising:
receiving outcome information regarding initial test offers provided to an initial set of customers, the initial test offers testing offers in the set of offers;
determining an allocatiton of additional test offers based on the outcome information, wherein determining the allocation comprises allocating the additional test offers unevenly amongst the offers in the set of offers to attain the desired confidence level that one of the offers is the best offer for the campaign;
receiving additional outcome information for the additional test offers and including the additional outcome information in the outcome information; and
determining the best offer with the desired confidence level based on the outcome information.

2. The method of claim 1, wherein allocating the additional test offers comprises:
identifying a first place offer and a second place offer in the set of offers based on the outcome information; and
allocating the additional test offers by allocating more of the additional test offers to each of the first and second place offers than to each of other offers in the set of offers.

3. The method of claim 1, wherein allocating the additional test offers further comprises allocating the additional test offers to the other offers in the set of offers based on an exploration weight, the exploration weight configured to ensure a sufficient amount of exploration of the other offers.

4. The method of claim 1, wherein allocating the additional test offers comprises:
solving an optimization to allocate the additional test offers, the optimization minimizing a total number of test offers allocated while allocating the additional test offers to eliminate overlap between a lower bounds of a first confidence interval for a first place offer and an maximum upper bounds of a second confidence interval of any other offer,
wherein the first confidence interval identifies that outcomes of the first place offer provided to all customers in the campaign will be within the first confidence interval with the desired confidence level, and the second confidence interval identifies that outcomes of another offer provided to all customers in the campaign will be within the second confidence interval with the desired confidence level.

5. The method of claim 1, wherein the method comprises iteratively performing the following operations until the best offer is determined with the desired confidence level:
reallocating the additional test offers based on all outcomes of test offers received;
distributing the additional test offers according to the allocation; and
assessing whether the best offer has been determined with the desired confidence level.

6. The method of claim 5, wherein assessing whether the best offer has been determined with the desired confidence level comprises comparing the first place offer and a second place offer using outcome information received so far.

7. The method of claim 5, wherein assessing whether the best offer has been determined with the desired confidence level comprises determining whether there is an overlap between a first confidence interval for a first place offer and a second confidence interval for any other offer in the set of offers.

8. The method of claim 1 further comprising distributing the initial test offers and the additional test offers.

9. The method of claim 1 further comprising, based on determining the best offer, distributing the best offer to customers in the campaign who did not receive test offers.

10. The method of claim 1, wherein distributing the best offer comprises sending an e-mail with the best offer to the customers in the campaign who did not receive test offers.

11. The method of claim 1, wherein the set of offers comprises three or more offers.

12. The method of claim 1, wherein the offers of the set of offers include offers promoting a same product or service using different offer contents, text fonts, text sizes, graphic sizes, text positions, graphic positions, offer formats, or offer distribution techniques.

13. A system for allocating test offers to determine a best offer in a set of offers with a desired confidence level, the system comprising:
a means for allocating test offers unevenly to test offers in the set of offers to attain the desired confidence level in a best offer for a campaign;
a means for determining the best offer with the desired confidence level based on the outcome information for the test offers; and
a means for distributing offers to customers in a campaign.

14. The system of claim 13, wherein the means for allocating test offers comprises a means for allocating more of the additional test offers to the first place offer and a second place offer than to other offers in the set of offers.

15. The system of claim 13 wherein the means for allocating test offers comprises a means for minimizing a total number of test offers allocated while allocating the additional test offers to eliminate overlap between a first confidence interval for a first place offer and a second confidence interval for a second place offer.

16. The system of claim 13 further comprising a means for iternatively reallocating and distributing additional test offers until the best offer is determined with the desired confidence level.

17. A non-transitory computer readable medium comprising instructions for causing a computing device to perform operations comprising:
allocating test offers unevenly to test offers in a set of offers to attain a desired confidence level in a best offer for a campaign;
receiving outcome information for the test offers; and
determining the best offer with the desired confidence level based on the outcome information for the test offers.

18. The non-transitory computer readable medium of claim 17, wherein allocating the test offers comprises:
identifying a first place offer and a second place offer in the set of offers; and
allocating the test offers by allocating more of the test offers to the first and second place offers than to other offers in the set of offers.

19. The non-transitory computer readable medium of claim 17, wherein allocating the test offers comprises:
identifying a first place offer and a second place offer in the set of offers; and
solving an optimization to allocate the test offers, the optimization minimizing a total number of test offers allocated while allocating the test offers to eliminate overlap between a first confidence interval for the first place offer and a second confidence interval for the second place offer,
wherein the first confidence interval identifies that outcomes of the first place offer provided to all customers in the campaign will be within the first confidence interval with the desired confidence level, and the second confidence interval identifies that outcomes of the second place offer provided to all customers in the campaign will be within the second confidence interval with the desired confidence level.

20. The non-transitory computer readable medium of claim 17, wherein, until the best offer is determined with the desired confidence level, the operations:
reallocate the test offers based on all outcomes of test offers received;
distribute the test offers according to the allocation; and
assess whether the best offer has been determined with the desired confidence level.
